(19) United States
(12) Patent Application Publication
(10) Pub. No.: US 2016/0074882 A1
(43) Pub. Date: Mar. 17, 2016

(54) Free-jet Device

(71) Applicant: Burkhard Büstgens, GUNDELFINGEN (DE)

(72) Inventor: Burkhard BÜSTGENS, GUNDELFINGEN (DE)

(21) Appl. No.: 14/849,951

(22) Filed: Sep. 10, 2015

(30) Foreign Application Priority Data
Sep. 11, 2014 (DE) 10 2014 013 158.0

(51) Int. Cl. B05B 1/02; B05B 1/30; B05B 1/14

(52) U.S. Cl. CPC B05B 1/02; B05B 1/14; B05B 1/3006

(57) ABSTRACT

It is proposed a free-jet device with at least one individually addressable channel for contact-free discharge of fluid through fluid discharge openings 10 and with a fluid supply 7, which applies a pressure on the fluid that is at least 0.2 bar higher with respect to the ambient pressure, wherein the at least one addressable channel comprises a valve unit including a fluid inlet channel 5 which has a valve opening 6 at the end thereof, the valve unit further including a closure element, which includes a membrane 2 and which is actuated by means of a pneumatic control pressure or by means of a steering force that corresponds to the respective addressable channel and which closes the valve opening 6 in a sealing position and releases the valve opening 6 in an opened position; a cavity 9 which is located behind the valve opening 6 in relation to the flow direction and which connects to one or more fluid discharge openings 10, wherein an outer part 3 of the membrane 2 is an integral part of the cavity 9.

The present invention relates to a method and an free-jet device for contact-free discharge of fluids on the surface of a body or a fluid. Fluids are, for example: Water or aqueous solutions, paints, especially emulsion paints, lacquers, especially solvent-based lacquers, especially automotive paints, suspensions or dispersions generally of solid particles in a liquid aqueous or non-aqueous phase, emulsions, liquid foodstuff, in a liquid phase dispersed, emulsified or gelled non-liquid powdery foodstuff, plasters, cements, clays, glazes or dispersions of glass powders, monomers, polymers, liquids with amino acids, particularly cells or their constituents.

Therefore, a contact-free fluid discharge can continuously take place in the form of a fluid-jet or discontinuously, which is generally referred to as Drop-on-Demand DOD method. However, the continuous form is considered here only as a special form of the Drop-on-Demand method, since a fluid-jet basically only corresponds to a drop discharge with particularly longer discharge time. Even those cases should be included in the Drop-on-Demand method, in which the fluid drops are torn apart or atomized after or during the discharge from the device by means of a gas under pressure.

Since the above described fluids often have a much higher viscosity than water, the here underlying DOD-Technology is assumed to be capable of applying sufficiently high power for producing drops. Such a technology is described in U.S. Pat. No. 8,556,373 B2. By means of an array of pneumatic micro-pilot valves pneumatic control pressures are generated, which in turn operate pneumatically controlled membrane-fluid valves. In this way, high switching powers can be achieved even within a minimum space. Therefore, U.S. Pat. No. 8,556,373 B2 proposes a mechanism as membrane-fluid valve, in which a membrane moved by the control pressure or a pneumatically moved valve tappet closes or opens the hole of an outlet. The opening of the valve takes place by the fluid pressure, as soon as this is greater than the control pressure, or, as soon as the control pressure drops below the fluid pressure. In order to achieve an effective sealing force, the control pressure must be substantially higher than the fluid pressure. Thus, there is a disadvantage of the method that in addition to the fluid pressure, a substantially higher control pressure must be provided. Another disadvantage of the described valve principle is that the closing of the valve, which determines the liquid break-off, does not take place as quickly as possible, since the increasing control pressure responsible for the closing of the valve is always reduced by the fluid pressure. Finally, another disadvantage of the design in U.S. Pat. No. 8,556,373 B2 results from the desire to realize more than one fluid outlet-opening per fluid valve. This desire exists, for example, if an area shall be coated with a thin layer of the emulsion paint. For this purpose another fluid sheet is required, which contains the desired number of fluid outlets per fluid valve.

Therefore, it is the object of the invention to provide an free-jet device and an free-jet method for the discharge of fluids of the above described type, which does not have the aforementioned disadvantages.

This object is achieved by the features of claim 1. Accordingly, it is assumed an free-jet device with at least one individually addressable channel for contact-free discharge of the fluid through fluid discharge openings 10 and with a fluid supply 7, which supplies fluid with a pressure, which is increased by at least 0.2 bar with respect to the environment, wherein at least one addressable channel includes the following: a valve unit with a fluid inlet channel 5 which has a valve opening 6 at the end thereof and with a closure element, which includes a membrane 2 and which is actuated by means of a pneumatic control pressure or by means of a steering force that corresponds to the respective addressable channel and which closes the valve opening 6 in a sealing position and releases the valve opening 6 in an opened position; furthermore, includes a cavity, which is in flow direction downstream from the valve opening 6 and which is connected to one or more fluid discharge openings 10, wherein an outer part 3 of the membrane 2 is an integral part of the cavity.

The free-jet device in accordance to the invention enables the use of a single pneumatic pressure source for generating control pressures and for applying pressure on the fluid. Further, an essential advantage compared to the mentioned state of art is, that with the free-jet device in accordance with the invention a substantially higher contact force of the membrane, thus a better sealing action can be achieved on the valve opening, because the fluid pressure opposing the control pressure acts only on an area of the size of the valve opening. Or to put it in another way, by use of a significantly lower control pressure the same contact pressure, thus the same sealing effect as in the state of the art, can be achieved. Therefore, the control pressure can be even significantly below the fluid pressure. Since, in practice, generating highly transient control pressures at high pressure is technologically complicated, the free-jet device in accordance with the invention can be used for generally overall increasing the power.

Another advantage compared to the state of the art is apparent, if an individually addressable channel shall have several fluid discharge openings 10, for example for producing a flat coating. For this purpose, another fluid plate must be added in the state of the art, which divides the one fluid outlet of the valve into a corresponding number of fluid discharge openings. In the free-jet device in accordance with the invention, the fluid discharge openings 10 are located in the same part, in which the remaining fluid channels are also located.

Finally, another advantageous effect can be obtained by a special fluidic design: If the fluid inlet channel 5 is designed as throttle with a high flow-resistance, then this and the fluid pressure applied determines the amount of fluid, which is discharged through the fluid discharge openings. For example, such a throttle can be formed with a capillary of a diameter of 0.1 mm to 0.5 mm and a length of 0.5 mm to 20 mm. In this mode of operation referred to as Inkjet mode here, the free-jet device in accordance with the invention during fluid discharge functions according to the positive displacement principle, since the fluid entered through the throttle is discharged through the fluid discharge openings 10, only driven by the membrane. Thus, still with valve opening times of 1 ms to 5 ms drop volumes in nanoliter range can be discharged.

The free-jet device in accordance with the invention mainly provides a contact-free discharge of drops or jets of the fluids through the fluid discharge openings 10, which mainly have a viscosity of 10 to 50 mPa in case of Newtonian behaviour or a viscosity of 5 to 30 mPa at a shear rate of 15000 l/s measured in case of a structurally viscous non-Newtonian behaviour. Primarily, fluid drops of volumes of 50 nanoliter to 1 millilitre with a frequency of 1 Hz to 1000 Hz at valve opening times between 0.2 ms and 5 ms, fluid pressures of 0.5 bar to 15 bar are discharged through the fluid discharge openings 10 with a cross-section of 0.1 mm to 6 mm.

The free-jet device in accordance with the invention is appropriate for a wide range of fluids and applications. It shall be especially emphasized here A coating of indoor or outdoor surfaces with building paints, particularly with water-based emulsion paints of the aforementioned properties and B coating of metallic surfaces in the industrial sector, for example, in the automobile manufacturing or in the aerospace technology, for the purpose of paint work. Both applications benefit by using the free-jet device in accordance to the invention from the fact, that in contrast to the known spraying processes, only fluid drops of defined size are generated for coating the surfaces, without forming finer fluid mist. This provides a favourable and economic contact-free coating process, which in principle completely avoids the environmentally harmful spray-mist. The usability of the free-jet device in accordance to the invention should also be noted in the field of additive layer manufacturing.

It is further provided in accordance with the invention that the fluid discharge openings 10 of an addressable channel are located in a matrix-arrangement of at least one row.

Furthermore, it is provided in accordance with the invention that the fluid discharge openings 10 of all addressable channels are located in a matrix-arrangement of at least one row.

Furthermore, it is provided in accordance to the invention that there is a distance D between the clamping level of the membrane 2 and the valve opening 6 at the end of the fluid inlet channel, so that the membrane is deflected by a distance D for closing the valve opening 6 by means of the control pressure.

Furthermore, it is provided in accordance with the invention that the fluid discharge openings 10 and the fluid inlet channel 5 are located within a common component.

Furthermore, it is provided in accordance with the invention that the fluid discharge openings 10 and the fluid inlet channel 5 extend substantially parallel to each other.

Furthermore, it is provided in accordance with the invention that the fluid discharge openings 10 and the fluid inlet channel 5 extend substantially perpendicular to each other.

Furthermore, it is provided in accordance with the invention that the fluid inlet channel has up to 20 times higher hydraulic flow resistance than the combined fluid discharge openings.

Furthermore, it is provided in accordance with the invention that the following steps are carried out for operating the free-jet device in accordance with the invention: Applying a control pressure on the membrane 2, so that the membrane 2 is pressed on the valve opening 6 at the end of the fluid inlet channel 5 in the initial position thereof, and applying a fluid pressure on the fluid, then reducing the control pressure, so that the membrane is deflected by the fluid pressure at the position of the membrane and lifted-off from the valve opening 6 at the end of the fluid inlet channel 5 and thus releases a fluid passage, then increasing the control pressure, so that the membrane 2 is again moved to the initial position thereof, therefore, the fluid is displaced, so that a fluid discharge through the fluid discharge openings 10 is effected.

Furthermore, it is provided in accordance with the invention that the control pressure for closing the valve opening 6 deviates from the fluid pressure at most by 0.3 bar.

Furthermore, it is provided in accordance with the invention that the free-jet device is operated such that the fluid discharge speed is 3 m/s to 12 m/s at the diameter of the discharge openings 10 of 0.1 mm to 0.5 mm.

Furthermore, it is provided in accordance with the invention that the free-jet device is operated such that the fluid discharge speed is 0.5 m/s to 6 m/s at the diameter of the fluid discharge openings 10 of 0.5 mm to 6 mm.

Furthermore, it is provided in accordance with the invention that the free-jet device is used for the purpose of discharging a structurally viscous fluid on a substrate, which has a viscosity of 5 to 50 mPa at a shear rate of 15000 l/s, by means of a fluid pressure of 2 to 6 bar, by means of at least one row of fluid discharge openings 10, which have a distance of 0.3 mm to 1.3 mm, to obtain a closed fluid film of 0.05 mm to 0.3 mm thickness.

### DESCRIPTION OF THE FIGURES

FIG. 1A shows a lateral section through the free-jet device in accordance with the invention with fluid discharge openings 10 directed downward, FIG. 1B with fluid discharge openings 10 directed towards left.

FIG. 2A, 2B, 2C and 2D illustrate the steps of a fluid discharge cycle.

FIG. 2E illustrates a specific embodiment.

FIG. 3A and FIG. 3B illustrate an embodiments of the fluid supply for a free-jet device in accordance with the invention.

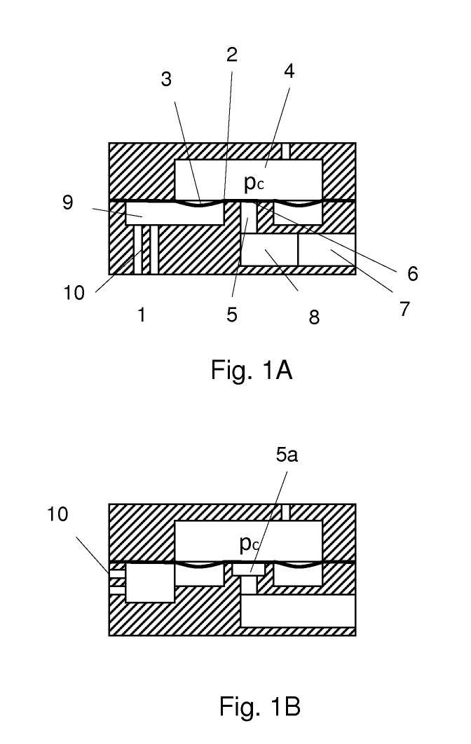

FIGS. 1A and 1B show a lateral section through an addressable channel, which in this context is understood as an individually controllable fluid valve, hereinafter called valve, with the associated in an out directed fluid lines, including one or more fluid outlets 10. If the smallest dimensions of a valve are substantially smaller than one millimetre, then this is also referred to as a micro valve. According to the invention, several of these addressable channels are disposed in a housing 1 in a regular arrangement, preferably in one or more rows. Fluid is supplied under pressure in a fluid inlet port 7. Optionally, the fluid can pass through a circulation duct 8, for example to counteract separation within the fluid. An addressable channel has a fluid inlet channel 5 leading from the circulation duct 8 or directly from the fluid inlet port 7. This can have a constant cross-section or can consist of several channel sections with different cross-sections. For example, the fluid inlet channel 5 may have at first a channel section with a small cross-section of 0.1 mm to 0.5 mm in flow direction and at the end a channel section with a larger cross-section 5a, for example of 0.3 mm to 1 mm. A valve is formed on the opening at the end of the fluid inlet channel 5, also referred to as valve opening 6 here. The face of the valve opening 6 serves as a valve seat. The width of the valve seat is between 0.03 mm and 0.2 mm and should be as small as possible. It is advantageous if the valve opening 6 at the end of a channel section with large cross-section 5a is, for example, of 0.3 mm to 0.7 mm, so that the fluid pressure acting on this large cross-section generates a greater force for opening the valve from the valve seat. Therefore, the opening is closed by a closure element, which seals the opening in a first closed position and releases the opening in a second opened position, so that fluid can flow through. The closure element preferably includes a membrane 2, which extends over the valve opening 6. Highly deformable, therefore preferably flat, thin shapes of elastic materials are accepted here as membranes in the direction of the valve inlet channel 5. Suitable are membranes of elastomer materials in a thickness of 20 to 200 micrometers, or thin metal membranes, for example of stainless steel in thicknesses of 2 to 20 micrometers, or membranes of thermoplastic or duroplastic materials with thicknesses of 10 micrometers to 150 micrometers or of composites thereof, or elastomer impregnated fabrics. The diameter of round membranes is, for example, 0.5 mm to 2 mm if the coating materials are to be applied, or 2 mm to 50 mm if concrete or plaster are to be applied. It is advantageous if the diameter of the valve opening 6 is one third to two thirds of the diameter of the membrane 2. A membrane can also be formed elongated, wherein the position of the valve inlet channel 5 is at least off-centre in one direction. The membrane 2 can further have a push rod shaped formation on the side of the opening 6 of the inlet channel, not shown here, which serves as closure element for the valve. Thus, the opening 6 is not closed by the membrane 2, but by the push rod, which takes over the function of a sealing element and further reduces the wear of the membrane, for example, by a particle filled fluid. The membrane 2 can have an elongated, angular, oval or round shape and is connected to the housing 1 along the clamping thereof. Therefore, the first side of the membrane serves to actuate the valve. The membrane can be mechanically actuated on the second side thereof by means of another push rod, preferably however, pneumatically by means of a pressure medium. Thus, the membrane 2 serves as a boundary of the fluid cavity at the position of the valve and for media separation of fluid and pressure medium, which is preferably a gas, particularly preferably compressed air.

In the closed condition of the valve, the control pressure pc comprises an overpressure with respect to the ambient, in the opened condition of the valve, the control pressure has a value in the range of the ambient pressure +/−0.1 bar, for example, which is achieved by ventilating the second side of the membrane. The fluid pressure, a prestressed or pre-deflected membrane or an additional spring element provide the driving force for opening the valve.

The fluid flows through a cavity within the housing 1 on the outlet side of the valve, which is referred to as valve outlet region 9. The cavity is additionally confined by the membrane 2 in an outer part of the membrane 2 and divides the fluid in one or more nozzles, or outlets, herein generally referred to as fluid discharge openings 10. The displacement volumes contained in the bulged membrane is catapulted out through the fluid discharge openings 10 during rapid closing of the membrane. Therefore, a part of the fluid flows back through the fluid inlet channel 5. As shown in FIG. 1A, the fluid discharge openings are directed downwards, thus extend parallel but in opposite direction to the fluid inlet channel. It is illustrated in FIG. 1B, that the fluid discharge openings 10 are directed towards left, thus perpendicular to the respective fluid inlet channel 5.

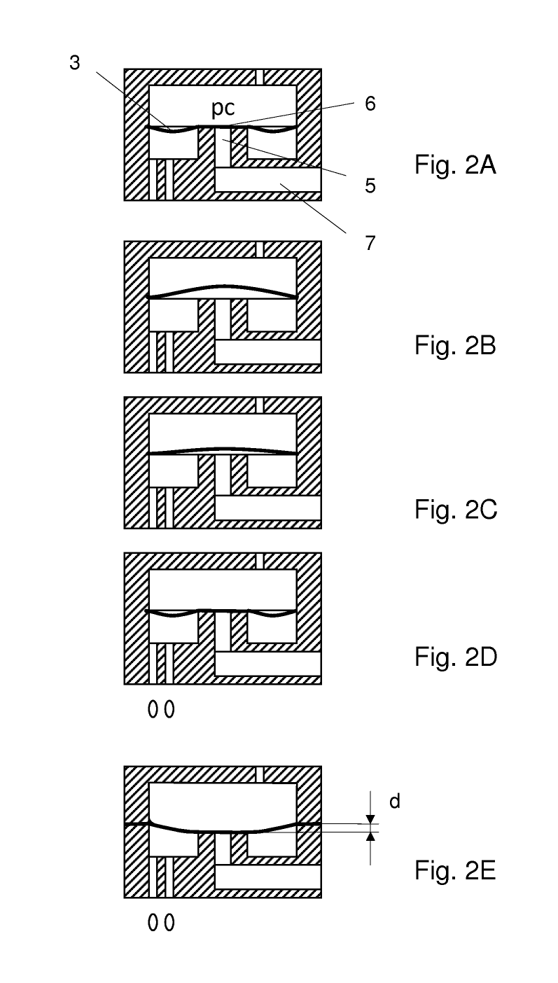

FIG. 2A to 2D illustrate the individual phases of a fluid discharge. Therefore, the construction is schematically shown in a lateral sectional view, size and shape of the different chambers can deviate in reality. The following we assume a pneumatic actuation of the membrane via a pressure medium, which for example is provided by pneumatic micro valves, which are not shown here. In the initial state in FIG. 2A, the membrane is pressed on the valve opening 6 by the control pressure pc and closes it. Fluid is supplied from the fluid supply under a pressure p_fl. It is an essential feature of the invention that the control pressure pc acts on the entire membrane area, while the fluid pressure p_fl acts only on the substantially smaller area of the valve opening 6. In this way, fluid can be switched, which has a higher pressure p_fl than the control pressure pc. The pressure ratio can be computed case-specific on the basis of a given sealing force of the membrane on the valve seat surrounding the valve opening 6, wherein the clamping forces and the deformation state of the membrane in the closed condition of the valve must be considered. These computations can be done by a person of average skill in the art.

The valve is opened by ventilating the control pressure to a lower pressure level, for example, to the ambient pressure. Therefore, the fluid pressure leads to bulging of the membrane and to the opening of the valve. Fluid flows out of the fluid inlet channel 5 through the opening 6 into the bulge of the membrane 2 and then further via the valve outlet region 9 to the fluid discharge openings 10. Therefore, the outlet region is confined by the walls of the housing and by an outer part 3 of the membrane in the region of the membrane. It can be configured as simple cavity or as finger-type distributing fluid-distribution structure. The free-jet device in accordance with the invention can be configured for the discharge of very small drops with a drop volume, for example, of below 100 nanolitres. For this, the fluid inlet channel 5 or even the flow zone, which in flow direction is located prior to it, are dimensioned such that they cause a throttling of the fluid flow, for example, by inserting an aperture plate with a cross-section of 0.05 mm to 0.5 mm or by a capillary duct with cross-sections between 0.1 mm and 0.5 mm and lengths of 1 mm to 20 mm. The fluid volumes transported during the valve opening time T is thus V_fl=dp*T/R, wherein dp is the pressure drop over the throttle zone and R is the flow resistance of the throttle zone. It is obvious, that by means of throttling the amount of fluid V_fl, which is discharged per shot through the fluid discharge openings 10, can be defined and can be very small by means of a high throttling or a small opening time. In the following it is assumed that, for example, with an opening time of 0.5 ms to 3 ms and under an applied fluid pressure of 0.5 bar to 5 bar, a fluid quantity of 50 to 500 nano liter flows into the valve and this volume approximately also corresponds to the displaced volume of the bulged membrane 2.

In FIG. 2C is is shown the state of the valve at the time of closing, which happens through a rapid pressure increase in the control pressure within 0.1 ms to 1 ms. Such a rapid increase of the control pressure leads to a rapid movement of the membrane to the closed position of the valve and thus leads to the displacement of the fluid volume previously contained in the bulged membrane. Consequently, in this phase the membrane acts as membrane-type fluid displacer and discharges the fluid out of the cavity 9. This mainly happens through the fluid discharge openings 10 and to a lesser extent through the fluid inlet channel 5, since on the one hand, the high static supply pressure p_fl and on the other hand, an optionally designed high flow resistance of the fluid inlet channel 5 prevent the backflow of fluid through the valve opening 6.

FIG. 2D finally indicates the state of the valve after discharge of the fluid. The release of a drop or fluid jet from a fluid discharge opening 10 is therefore supported by the swinging back of the outer part 3 of the membrane 2, thus by a slight backflow of fluid. Thus, it is apparent that the free-jet device in accordance with the invention combines the advantages of a valve principle with that of the displacement principle.

Consequently, it is suggested in accordance with the invention, that in an inkjet mode the fluid pressure, the valve opening time and the fluid resistance of the fluid inlet channel are configured such that the fluid quantity discharged through the associated fluid discharge openings 10 is smaller than the volume displaced by the membrane 2.

Furthermore, it is suggested in accordance with the invention that in a jet-mode the fluid pressure, the valve opening time and the fluid resistance of the fluid inlet channel are measured such that the fluid quantity discharged through the associated fluid discharge openings 10 is greater than the volume displaced by the membrane 2.

By this the volume displaced by the membrane can be increased by enlarging the membrane 2 to such an extent, that it almost completely covers the cavity of the valve outlet zone 9, or by adding further membranes which are connected to the valve outlet zone 9 and which are actuated to the control pressure pc.

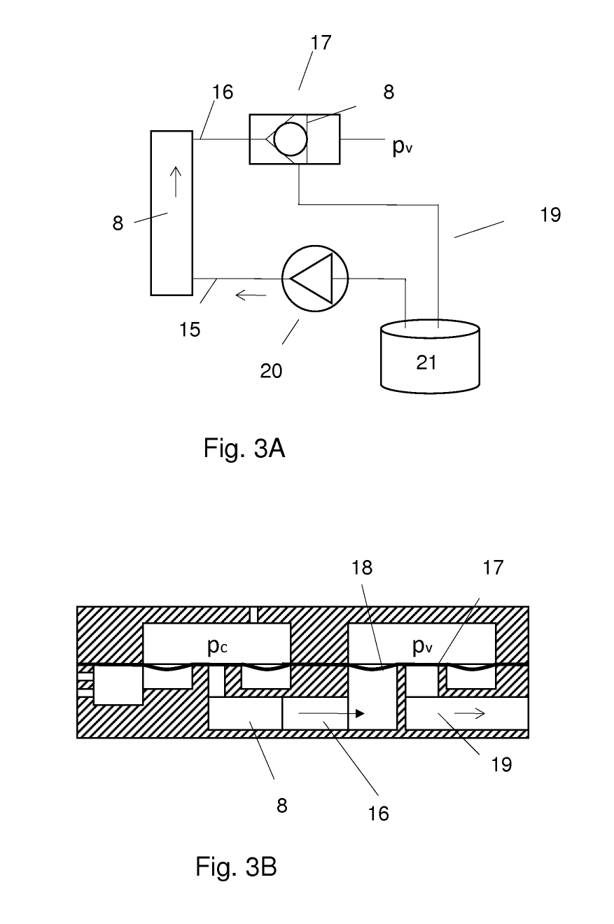

The fluid can be supplied from a pressurized tank in the simplest case. Alternatively, a fluid circulation system can be used, as shown in FIG. 3A, in which the fluid is delivered by means of a pump 20: From a reservoir 21, via the pump 20, via an intake 15 to the circulation zone 8, via the circulation zone 8, from which the fluid inlet channels 5 depart, via an outlet 16 from the circulation zone 8, via a pressure regulating valve 17 controlled by a pneumatic pressure pv, and back again to the reservoir 21 through a return line 19. In FIG. 3B a configuration in accordance with the invention is shown comprising a pressure regulating valve 17 integrated within the housing 1 of the free-jet device, which is controlled by the supply pressure pv, wherein the pressure pv is also used for generating the control pressure pc. Thus for example, the circulation system can be operated such, that the fluid pressure automatically remains in a constant relationship with the control pressure pc in case of closed valves. Such a pressure regulating valve, shown on the right in FIG. 3B, is known to the average skilled person and is similar in its functionality to the fluid discharge valves, however with reversed flow direction. The membrane valve is formed of the membrane 18, which is pressed on a circular valve seat by the pressure pv. The valve opens above a fluid pressure, which can be adjusted by pv.

The commercial use of the invention includes, for example, applying a paint on base of a polymeric emulsion, an emulsion paint, on the surface of a building, which primarily has a viscosity of 5 to 30 mPa, measured at a shear rate of 15000 l/s, and with particles contained therein, the diameter of which significantly do not exceed 70 micrometers. Primarily, fluid drops of 50 nanoliters to 1 microliter with a frequency of 1 Hz to 1000 Hz with valve opening times between 0.2 ms and 2 ms, fluid pressures of 0.5 bar to 8 bar are discharged through the fluid discharge openings 10 with a cross-section of 0.1 mm to 0.5 mm. Therefore in one configuration with a diameter of the fluid discharge openings 10 of 0.1 mm to 0.5 mm, the fluid is discharged with a discharge speed of 3 m/s to 12 m/s. Therefore, the fluid discharge openings 10 are arranged in an array such that the average area coated by an individual fluid discharge opening on a substrate is between 0.25 mm² and 1 mm², or the average distance of the fluid discharge openings 10 is 0.5 mm to 1 mm. Thus, the method in accordance with the invention has distinctly greater nozzle pitch compared to the state of art in inkjet printing. Wet layer thicknesses obtained therefrom are, for example, 0.04 mm to 0.3 mm.

The commercial use of the invention can also include applying liquid concrete or plaster, or in general, a construction material, which is available as liquid emulsion with inorganic particles.

According to the invention, therefore, a liquid concrete can be applied in multiple layers of variable geometry, which contains solid components of cements and sands with particle sizes up to 0.3 mm in amount of 30% to 70%, with thickeners of 0.5% to 5% for selectively increasing the viscosity in the range of shear rate up to 100 l/s, with thickeners for viscosity increase in the entire range of shear rate and other additives, with a viscosity of 15 to 70 mPa, measured at a shear rate of 15000 l/s, discharged in the form of drops of 1 microliter to 10 milliliters with a frequency of 1 Hz to 1000 Hz at valve opening times of 1 ms to 20 ms, or in the form of fluid jets of variable duration. Therefore, the fluid discharge openings 10 are arranged in an array such that the average pitch of the fluid discharge openings 10 is 2 mm to 20 mm and the average area coated on a substrate is between 4 mm² and 500 mm² in case of the drop discharge from an individual fluid discharge opening. Therefore, the layer thickness is 0.1 to 2 times the pitch of the discharge openings 10. Therefore in one configuration, the fluid is discharged with a discharge speed of 0.5 m/s to 8 m/s at a diameter of the fluid discharge openings 10 of 0.5 mm to 6 mm.

1. Free-jet device with at least one individually addressable channel for contact-free discharge of fluid through fluid discharge openings 10 and with a fluid supply 7, which applies a pressure on the fluid that is at least 0.2 bar higher with respect to the ambient pressure, wherein the at least one addressable channel comprises
a valve unit including a fluid inlet channel 5 which has a valve opening 6 at the end thereof,
the valve unit further including a closure element, which includes a membrane 2 and which is actuated by means of a pneumatic control pressure or by means of a steering force that corresponds to the respective addressable channel and which closes the valve opening 6 in a sealing position and releases the valve opening 6 in an opened position;
a cavity 9 which is located behind the valve opening 6 in relation to the flow direction and which connects to one or more fluid discharge openings 10, wherein an outer part 3 of the membrane 2 is an integral part of the cavity 9.

2. Free-jet device according to claim 1, characterized in, that the fluid discharge openings 10 of at least one addressable channel are arranged in a matrix-arrangement of at least one row.

3. Free-jet device according to claim 1, characterized in, that there is a distance D between the clamping plane of the membrane 2 and the valve opening 6 at the end of the fluid inlet channel.

4. Free-jet device according to claim 1, characterized in, that the fluid discharge openings 10 and the fluid inlet channel 5 are located within a common housing 1.

5. Free-jet device according to claim 1, characterized in, that the fluid discharge openings 10 and the fluid inlet channel 5 extend substantially parallel or perpendicular to each other.

6. Free-jet device according to claim 1, characterized in, that the fluid inlet channel has a higher hydraulic flow resistance than the combined fluid discharge openings.

7. Method for fluid discharge with a free-jet device according to claim 1, characterized by the following steps:
applying a control pressure on membrane 2, so that the membrane 2 is pressed on the valve opening 6 at the end of the fluid inlet channel 5 in the initial position thereof and applying a fluid pressure on the fluid,
reducing the control pressure, so that the membrane lifts off from the valve opening 6 at the end of the fluid inlet channel 5 under the influence of the fluid pressure and thus releases a fluid passage,
increasing the control pressure, so that the membrane 2 is moved back to the initial position thereof, thereby displacing fluid, thus effecting a fluid discharge through the fluid discharge openings 10.

8. Method according to claim 7, characterized in, that the control pressure for closing the valve opening 6 deviates at most by 0.3 bar from the fluid pressure.

9. Method according to claim 7, characterized in, that the fluid is discharged with a discharge speed of 3 m/s to 12 m/s, wherein the diameter of the discharge openings 10 is 0.1 mm to 0.5 mm.

10. Method according to claim 7, characterized in that, the fluid is discharged with a discharge speed of 0.5 m/s to 8 m/s, wherein the diameter of the discharge openings 10 is 0.5 mm to 6 mm.
